(19) United States
(12) Patent Application Publication
(10) Pub. No.: US 2006/0181993 A1
(43) Pub. Date: Aug. 17, 2006

(54) Apparatus for an method of recording digital information signals

(75) Inventors: Johannis Friso Rendert Blacquiere, Eindhoven (NL); Pope Ijtsma, Eindhoven (NL); Dirk Hamelinck, Eindhoven (NL); Robert Albertus Brondijk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/563,645

(22) PCT Filed: Jul. 1, 2004
(86) PCT No.: PCT/IB04/51088

§ 371 Date: Jan. 6, 2006

(30) Foreign Application Priority Data
Jul. 8, 2003 (EP) 03102035.7

(51) Int. Cl. G11B 7/00

(52) U.S. Cl. 369/53.17

(57) ABSTRACT

A recording apparatus for recording digital information signals on a removable rewritable disc like recording medium has been proposed. The apparatus comprises writing means (21, 22, 25) for recording the digital information signals and control means (20) for controlling the recording. The apparatus is capable of performing initialization, formatting and defect management of a rewritable medium. Further, the apparatus is capable of storing first file system data in a user area (UA) and second file system data in a general application area (GAA) on the medium. The control means (20) are adapted to enlarge GAA and to store the second file system data in it. This increases a number of files in UA, which can be addressed by the second file system data.

The invention relates to a recording apparatus for recording digital information signals on a removable rewritable disc like recording medium, the medium comprising a user area for recording user data represented by the digital information signals and for recording first file system data comprising directory and file entries pointing to the user data according to rules of a first file system, a spare area outside the user area comprising replacement areas for defect management, a table area outside the user area for recording a defect table comprising a list of addresses of the replacement areas and defect areas in the user area, a general application area outside the user area and outside the spare area for recording second file system data comprising directory and file entries pointing to the user data according to rules of a second file system, the recording apparatus comprising
input means for receiving the digital information signals;
recording means for recording the digital information signals on the medium;
reading means for reading recorded digital information signals recorded on the medium;
output means for outputting the read digital information signals; and
control means for controlling recording the digital information signals.

The invention further relates to a method of recording digital information signals on a removable rewritable disc like recording medium, the medium comprising a user area for recording user data represented by the digital information signals and for recording first file system data comprising directory and file entries pointing to the user data according to rules of a first file system, a spare area outside the user area comprising replacement areas for defect management, a table area outside the user area for recording a defect table comprising a list of addresses of the replacement areas and defect areas in the user area, a general application area outside the user area and outside the spare area for recording second file system data comprising directory and file entries pointing to the user data according to rules of a second file system.

The invention also relates to a computer data system comprising a computer connected to a recording apparatus for recording digital information signals on a removable rewritable disc like recording medium, the medium comprising a user area for recording user data represented by the digital information signals and for recording first file system data comprising directory and file entrics pointing to the user data according to rules of a first file system, a spare area outside the user area comprising replacement areas for defect management, a table area outside the user area for recording a defect table comprising a list of addresses of the replacement areas and defect areas in the user area, a general application area outside the user area and outside the spare area for recording second file system data comprising directory and file entries pointing to the user data according to rules of a second file system, the recording apparatus comprising
input means connected to the computer for receiving the digital information signals;
recording means for recording the digital information signals on the medium;
reading means for reading recorded digital information signals recorded on the medium;
output means for outputting the read digital information signals to the computer; and
control means for controlling recording the digital information signals.

The invention further relates a computer program product for recording digital information signals on a removable rewritable disc like recording medium.

Recording media like optical discs (DVD+RW, Blu-Ray, etc.) are capable of storing large amount of data of different types. They can be used in different environments having specific requirements as for organization of data on a recording medium. Typically, data are organized into files in accordance with rules of a particular file system. Such file system has its own file system data, which include information about all kind of structures relating to data stored on a recording medium. In particular, file system data may include volume structures representing the structures of logical and/or physical volumes, file structures representing the structures of files containing the data, directory structures describing grouping of files, and a space bitmap representing allocated or unallocated space for storing data on a recording medium. File system data are stored on a recording medium in an administrative area of a file system. A recording medium may comprise addressable recording units for storing the data. At a level of a file system those units are referenced to with use of logical addresses defining addressing space. Partitioning of a recording medium allocates a space on the medium for storing data under control (according to rules) of a file system.

At present, for example, DVD+RW discs are in use by Consumer Electronics (CE) devices and in the Personal Computer (PC) environment. In the CE environment DVD+RW discs are used mainly for recording digital video information according to a specific format Like DVD Video Recording (DVD+VR). This means that there are defined specific allocation rules and set of files containing the video information itself and information about that video information such as title information, menu structures, etc. For example, in the DVD+VR format some (file system) pointers are located at fixed address positions; also, certain files start at fixed addresses. Next to that the (predefined) list of files has to be physically on a medium in a certain order.

The PC environment is based on a different philosophy. There are, in principle, no allocation requirements. Specific applications may require some files to be present in a certain directory and specific application will typically have their own data format to store information in files or to retrieve information from a file. This means that as long as there is free space available on a medium it is possible to add data files to that medium from all kinds of different applications. As an example, on a single disc there could be multi-media files, text files and executable files all mixed with each other.

Recently, more and more CE devices, like video players/recorders, have capability to seek through the file system information on the disc for files of a certain type that they can handle as well. Example of this are (mainly) JPEG files and also, already more and more, MP3 files. In the future possibly more types of multi-media files will be supported in the CE world. Next to that, also new standards on meta-data are created (such as e.g. MPV or HighMAT) designed to make it easier to move digital content between PCs and home electronics devices.

The published international patent application WO 01/22416 A1 discloses the recording apparatus capable of performing initialization, formatting and defect management of a rewritable medium such as a CD-RW disc. This is done to facilitate the use of CD-RW as a high-capacity floppy disc, so immediate writing or reading of files is possible. Such media are commonly referred to as Mount Rainier ReWritable (MRW) media, e.g. CD-MRW, DVD+MRW.

Further, said recording apparatus makes it possible to store file system data of different file systems on one recording medium, so-called “bridge medium”. This facilitates sharing of the bridge medium between different environments, e.g. the CE environment and the PC environment. A special part of a recording medium, called a general application area (GAA), is allocated for storing file system data of a file system used by other devices not capable of performing the defect management as defined in WO 01/22416 A1. In case of DVD+MRW media, GAA has a size of 2 MBytes. This puts a limit on a number of files the file system data in GAA can point to. For example, one file entry in the UDF file system data occupies 2 KBytes, so the number of files is limited to about 1000. Content layout rules on a medium of a typical CE system may require additional files (like in case of DVD+VR format), which is another limiting factor.

It is an object of the invention to overcome those limitations and, generally, to improve exchangeability of media between different environments.

This object is achieved, according to a first aspect of the invention, by a recording apparatus of the type described in the opening paragraph, characterized in that the control means are adapted to mark a part of the medium as unusable in the defect table and to record the second file system data in the part of the medium marked as unusable. This increases the number of files, which can be addressed by the second file system data while avoiding a conflict with the first file system data and the defect management.

In an embodiment of the recording apparatus, the control means are adapted to mark at least a part of the spare area as unusable in the defect table and to record the second file system data in the at least the part of the spare area marked as unusable. This embodiment is advantageous in that storing the second file system data does not affect the user area.

In a further embodiment of the recording apparatus, the control means are adapted to search the defect table for a replacement area address of a replacement area comprising recorded user data, to localize the replacement area according to the replacement area address, to search the defect table for a free replacement area address of a free replacement area without the user data, to localize the free replacement area according to the free replacement area address, to read the recorded user data from the replacement area, to record the user data read from the replacement area in the free replacement area and to mark the replacement area as unusable in the defect table. This protects the user data recorded in the spare area from being erased while recording the second file system data.

In another embodiment of the recording apparatus, the control means are adapted to mark and to allocate the part of the medium, which part comprises a part of the user area. This is advantageous in that it provides a possibility to very significantly increase a storage space for the second file system data.

It is advantageous, if the control means are adapted to search the defect table for a free replacement area address of a free replacement area without the user data, to localize the free replacement area according to the free replacement area address, to read recorded user data from the part of the user area, to record the user data read from the part of the user area in the free replacement area and to mark the part of the user area as unusable in the defect table. This protects the user data recorded in the user area from being erased while recording the second file system data.

A further embodiment of the recording apparatus is characterized in that the control means are adapted to collect change information related to changes of the first file system data or of the second file system data and to modify the first file system data or the second file system data in dependence on the change information. This ensures that different file system data are synchronized.

In yet another embodiment of the recording apparatus, the control means are adapted to record the change information on the medium. This embodiment is advantageous in that it improves access to the change information, specially while moving the medium between devices.

It is advantageous, if the control means are adapted to collect status information related to changes of the defect table and to modify the second file system data in dependence on the status information. This ensures that file entries comprised in the second file system data contain correct links to the user data after changes resulting from actions taken by the defect management.

According to a second aspect of the invention a method of recording digital information signals of the type described in the opening paragraph is provided characterized by
marking a part of the medium as unusable in the defect table;
allocating the part of the medium for recording the second file system data.

According to a third aspect of the invention a computer data system of the type described in the opening paragraph is provided, characterized in that the computer is adapted to control the control means of the recording apparatus to perform the method as described in relation to the second aspect of the invention.

According to a forth aspect of the invention a computer program product for recording digital information signals is provided, which program is operative to cause a processor to perform the method as described in relation to the second aspect of the invention.

These and other aspects of the invention will be apparent from and elucidated further with reference to the embodiments described by way of example in the following description and with reference to the accompanying drawings, in which:

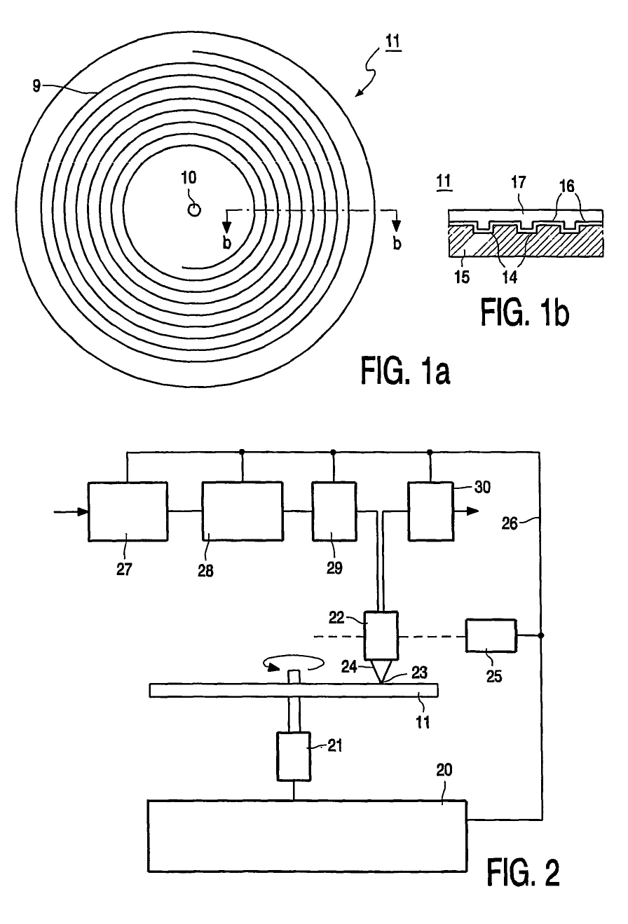

FIG. 1a shows a recording medium (top view),

FIG. 1b shows a recording medium (cross section),

FIG. 2 shows a recording apparatus, in accordance with the invention,

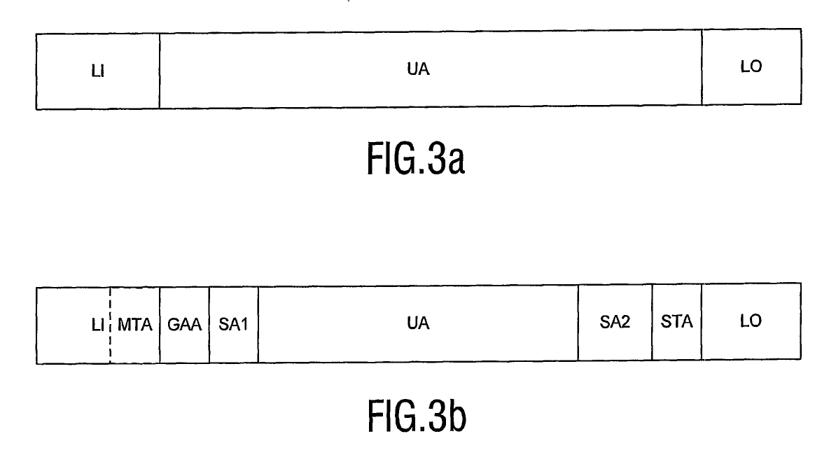

FIG. 3a shows a simplified layout of a non-MRW type of medium,

FIG. 3b shows a simplified layout of a MRW type of medium,

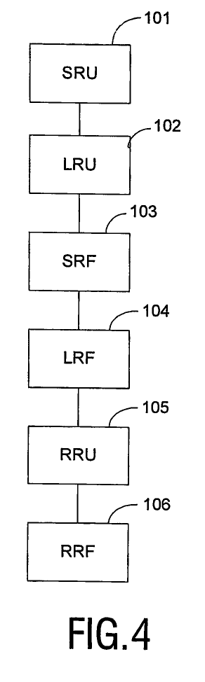

FIG. 4 shows an example of a method of expanding GAA into a spare area on the recording medium, in accordance with the invention.

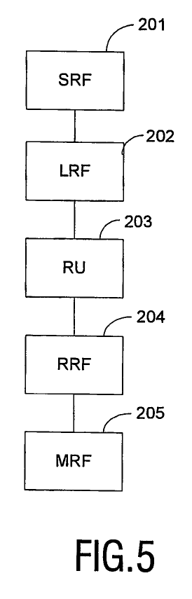

FIG. 5 shows an example of a method of expanding GAA into a user area on the recording medium, in accordance with the invention.

Corresponding elements in different Figures have identical reference numerals.

FIG. 1a shows an example of a recording medium 11 having a form of disc with a track 9 and a central hole 10. The track 9, being the position of the series of (to be) recorded marks representing digital information signals (data), is arranged in accordance with a spiral pattern of turns constituting substantially parallel tracks on an information layer. The recording medium may be optically readable, called an optical disc, and has an information layer of a recordable type. Examples of a recordable disc are the CD-RW, and writable versions of DVD, such as DVD+RW, and the high density writable optical disc using blue lasers, called Blu-ray Disc (BD). Digital information signals (data) are represented on the information layer by recording optically detectable marks along the track, e.g. crystalline or amorphous marks in phase change material. The track 9 on the recordable type of recording medium is indicated by a pre-embossed track structure provided during manufacture of the blank recording medium. The track structure is constituted, for example, by a pregroove 14, which enables a read/write head to follow the track during scanning. The track structure comprises position information, e.g. addresses, for indication the location of units of information, usually called information blocks or packets.

FIG. 1b is a cross-section taken along the line b-b of the recording medium 11 of the recordable type, in which a transparent substrate 15 is provided with a recording layer 16 and a protective layer 17. The protective layer 17 may comprise a further substrate layer, for example as in DVD where the recording layer is at a 0.6 mm substrate and a further substrate of 0.6 mm is bonded to the back side thereof. The pregroove 14 may be implemented as an indentation or an elevation of the substrate 15 material, or as a material property deviating from its surroundings.

FIG. 2 shows a recording apparatus for recording digital information signals a recording medium 11 such as CD-RW, DVD+RW or BD, in accordance with the invention. The apparatus is provided with writing means for scanning the track on the recording medium, which means include a drive unit 21 for rotating the recording medium 11, a head 22, and a positioning unit 25 for coarsely positioning the head 22 in the radial direction on the track. The head 22 comprises an optical system of a known type for generating a radiation beam 24 guided through optical elements focused to a radiation spot 23 on a track of the information layer of the recording medium. The radiation beam 24 is generated by a radiation source, e.g. a laser diode. The head further comprises (not shown) a focusing actuator for moving the focus of the radiation beam 24 along the optical axis of said beam and a tracking actuator for fine positioning of the spot 23 in a radial direction on the center of the track. The tracking actuator may comprise coils for radially moving an optical element or may alternatively be arranged for changing the angle of a reflecting element. For writing digital information signals (data) the radiation is controlled to create optically detectable marks in the recording layer. The marks may be in any optically readable form, e.g. in the form of areas with a reflection coefficient different from their surroundings, obtained when recording in materials such as dye, alloy or phase change material, or in the form of areas with a direction of magnetization different from their surroundings, obtained when recording in magneto-optical material. For reading, the radiation reflected by the information layer is detected by a detector of a usual type, e.g. a four-quadrant diode, in the head 22 for generating a read signal and further detector signals including a tracking error and a focusing error signal for controlling said tracking and focusing actuators. The read signal is processed by read processing unit 30 of a usual type including a demodulator, deformatter and output unit to retrieve the digital information signals (data). Hence retrieving means for reading information include the drive unit 21, the head 22, the positioning unit 25 and the read processing unit 30. The apparatus comprises write processing means for processing the input digital information signals (data) to generate a write signal to drive the head 22, which means comprise an input unit 27, and modulator means comprising a formatter 28 and a modulator 29. The input digital information signals (data) may comprise for example real-time video and/or audio data or still images data. The input unit 27 processes the input data to units of information, which are passed to the formatter 28 for adding control data and formatting the data, e.g. by adding error correction codes (ECC) and/or interleaving. For computer applications units of information may be interfaced to the formatter 28 directly—in such case, as an option, the input unit 27 does not have to be present in the apparatus. The formatted data from the output of the formatter 28 is passed to the modulation unit 29, which comprises for example a channel coder, for generating a modulated signal, which drives the head 22. Further the modulation unit 29 comprises synchronizing means for including synchronizing patterns in the modulated signal. The formatted units presented to the input of the modulation unit 29 comprise address information and are written to corresponding addressable locations on the recording medium under the control of control unit 20. Further, the apparatus comprises a control unit 20, which controls the recording and retrieving of information and may be arranged for receiving commands from a user or from a host computer. The control unit 20 is connected via control lines 26, e.g. a system bus, to said input unit 27, formatter 28 and modulator 29, to the read processing unit 30, and to the drive unit 21, and the positioning unit 25. The control unit 20 comprises control circuitry, for example a microprocessor, a program memory and control gates, for performing the procedures and functions according to the invention as described below. The control unit 20 may also be implemented as a state machine in logic circuits. The control unit 20 is capable of performing initialization, formatting and defect management of a rewritable medium such as a DVD+RW disc. An example of simplified layout of such disc is shown in FIG. 3b. It comprises lead-in area LI, lead-out area LO, a general application area GAA, a spare area SA (in this example comprising two sub-areas SA1 and SA2), a user area UA, and table areas MTA and STA. LI and LO contain mainly media read/write definition and administration data. The user area UA is used mainly for recording of data used for real use and data related to content stored on a recording medium, such as user data and first file system data comprising directory and file entries pointing to the user data according to rules of a first file system. The general application area GAA can be used for storage of data that does not allow replacements by the defect management, such as application programs or device drivers that can handle defects, or file system data of additional file systems. The defect management is based on a main defect table MDT stored in a main table area MTA, a secondary defect table SDT stored in a secondary table area STA and replacement areas (packets) comprised in the spare area SA1, SA2. The secondary defect table is a copy of the main defect table; SDT contains the same information as MDT. STA As used as redundancy in case of issues with MTA, and for assuring that non-MRW PC-systems can use these tables for address remapper in order to logically construct the address space, compensating for the defect management reallocation (not interpretable by non-MRW drives). The main table area MTA is located within the lead-in area LI. Recording media with a layout of the type shown in FIG. 3b are commonly referred to as Mount Rainier ReWritable (MRW) media, e.g. CD-MRW or DVD+MRW, in contrast to “non-MRW” media with a layout as in example shown in FIG. 3a. In case of DVD+MRW recording media, GAA, SA1 and SA2 have a size of 2, 8 and 120 MBytes, respectively.

Based on the MRW definitions, it is possible to ensure that MRW media can be read by non-MRW capable drives, by installing a remapping driver on the PC. This remapping driver can be obtained easily, amongst other, by using GAA, such that the file system in GAA launches an application, which installs this driver or downloads it from the Internet. For convergence with non-MRW aware CE devices, the same or a different file system, (typically ISO9960 or UDF) can be used for allowing addressing of the content typically recognized by CE devices. This is done by pointing to the multimedia content stored in UA of the MRW medium, using file system data stored in GAA, hereinafter also referred to as second file system data, known by CE devices. There can be an extra file system in GAA, dedicated to performing tasks related to the remapping driver.

A defect table contains information, which can be used to perform the defect management. In particular, the defect table contains a list of defective areas (packets), which have been determined to be defective during verification or during use of the medium, according to rules of the defect management. Further, it contains a list of replacement areas (packets), reserved to be used as replacements of defective areas. Defective and replacement areas are referred to by their addresses on the medium. Different flags or status bits within the defect table indicate characteristics of those areas, e.g. usability for data recording. The defect table also contains information related to areas on the medium, where the defect management shall not be active, such as a size and position of GAA.

The control unit 20 is adapted to mark a part of the medium as unusable in the defect table, in order to reserve it for other use than data recording under the defect management. In particular, the control unit 20 is adapted to record second file system data in this part of the medium; those data can be employed by “non-MRW” devices or systems (generally, without or different built-in defect management functionality) to access the user data. At least the base structures of the second file system (like anchor) always need to be in the standard GAA in order to allow the second file system to be mounted in CE-devices or any device without MRW knowledge.

In an embodiment, the part of the medium marked as unusable in the defect table is allocated for GAA and information related to this allocation is recorded on the medium, e.g. in the defect table. This effectively increases the size of GAA.

On the MRW medium with the CE-bridge usage capabilities, user files are recorded in UA together with the file system information (data) about these files. This is exactly the same as happens on the normal MRW medium.

The enlarged GAA can be used to present a “CE adapted” view of the user files present in UA. This means that a file system structure (the second file system data) with links to data files in UA is created in the enlarged GAA, according to CE requirements. For example, if there is DVD structured data present in UA, a file system structure according to the DVD(+VR) standard is created. Based on this file structure, this “MRW for CE enabled medium” will play in all (CE) DVD players. Other data that is of interest for CE devices (such as multi-media files or meta-data files) can be in the file system structure in GAA, as well. A predetermined directory layout for various multi-media files can be defined in this file system structure. For example, all MP3 files in UA can appear in a single directory called MP3 from a CE device point of view, independently of the directory they are put in inside UA. In a similar way, all JPEG files can be put in a directory called JPEG or PHOTOS. Of course, it is still possible to a have a further directory structure inside those directories, based on e.g. the original location or the creation date of these files. The advantage of this approach is that CE devices do not have to search through a large amount of directory trees to find all files that are of interest for them. All interesting files from a CE point of view can appear in one directory (e.g. MULTIMEDIA) or just in a limited number of directories based on the file types present on the medium.

The number of files in UA may be very high and related file systems relatively complex. In this case a special playlist and meta-data based solutions, like MPV, may be used for easy access, playback and storage of the content in UA. Such solutions may allow “write” functionality for non-MRW aware CE devices that can handle MPV information, as the MPV information stored on the medium can be used to restore integrity of the data in the PC environment by using autolaunch applications as described above, but now for a MPV application on the medium, stored in UA and/or GAA.

In an embodiment, the control unit 20 is adapted to indicate at least a part of the spare area SA, as unusabie in the defect tadle and to record second file system data in it.

First, space in SA1 (SA2) is freed-up by moving content in SA1 (SA2) to free areas, based on information from MDT. This can be done by e.g. background action of the apparatus, or can be the result of a special format command, which transforms “normal” MRW layout to a special one as hereunder. The freed-up SA locations are marked as unusable in the defect table. As a result, these locations will not be overwritten in MRW systems. These locations are added to the GAA space, by allowing the GAA read/write addressing system to actively read/write in the new GAA layout by use of extended address rules. This change in size and layout of the GAA can be stored on the medium for future use in systems knowing this convergence solution. If the convergence file system (second file system) needs special files after the content in UA, then these can be recorded in the SA2 portion added to the GAA space.

A particular method performed by the control unit 20 of an embodiment of the apparatus, is shown in FIG. 4.

In step 101, MDT is searched for a replacement area address of a replacement area comprising user data, which is then localized on the medium according to its address in step 102. Analogously, in steps 103 and 104, a free replacement area, i.e. replacement area, which does not contain user data, is searched for and localized according to its address. After reading the user data from the replacement area (step 105) and re-recording this data in the free replacement area (step 106), the replacement area is marked as unusable in MDT.

Allocating the whole SA1 space for GAA gives extra 8 MBytes for storing the second file system data; this means about 4000 additional file/directory entries in case of UDF as the second file system. If necessary, a part of or even all 120 MBytes of SA2 space can be used for this purpose.

Alternatively, or in addition to the space from SA, a part of UA can also be allocated for GAA and used for recording the second file system data.

This can be achieved by changing the user area available to the file system in UA—making parts of the file system space unusable or getting parts out of the file system allocation space. Next, the freed space can be added to the GAA space, e.g. by means of a special table of freed up addresses. This special table can be included in the defect table.

In another embodiment of the apparatus, the control unit 20 is adapted to indicate a part of the user area UA, as unusable in the defect table and to record second file system data in it.

Extending GAA into UA is done almost the same way as extending GAA into SA, as described above, but now by copying content of the beginning of UA to free location(s) in SA (e.g. in SA2, if SA1 is allocated for GAA), creating related defect tables entries in MDT (and SDT) and marking the original UA location(s) as unusable in the defect tables. This allows to enlarge GAA into these freed-up location(s); in this way e.g. 100 MBytes of space can be easily added to GAA, thus breaking almost all use limits for the size of the (second) file system data used for the CE convergence.

In an embodiment, the control unit 20 is adapted to perform a method as shown in FIG. 5, thus to search MDT for a free replacement area address of a free replacement area without the user data (step 201), to localize the free replacement area according to the free replacement area address (step 202), to read recorded user data from the part of the user area UA (step 203), to record the user data read from the part of the user area UA in the free replacement area (step 204) and to mark the part of the user area UA as unusable in MDT (step 205).

In an embodiment, the control unit 20 is adapted to select a part of UA out of the first file system allocation space and add it to the GAA space. This means that no user data can be stored in this part of UA under control of the first file system. This part can be added to GAA by means of a special list of freed up addresses comprised in the defect table.

By storing data structures of different file systems on one storage medium, the control unit 20 facilitates sharing of the medium, so-called “bridge medium” between different environments, e.g. the CE environment and the PC environment. The control unit 20 functions as so-called “bridge application”. File and directory entries comprised in the data structure of one file system are mirrored in equivalents of other data structure belonging to other file system. After addition (modification) of the data on the bridge medium, file systems data must be synchronized by the bridge application. Depending whether the medium is used in a “knowledgeable” environment, i.e. the environment wherein it can be assured that two file systems data are kept synchronized, or in an “unknowledgeable” environment (where the two file systems data can not be kept synchronized), the medium may have correct or incorrect CE bridge information, respectively. Therefore special actions of a special convergence application able to restore the CE bridge, have to be performed. This could be a part of the functionality of the “knowledgeable” environment, to assure the medium always leaves this environment with a correct CE bridge stored in GAA.

In an embodiment, the control unit 20 is capable of restoring the CE bridge, i.e. restoring synchronization between the two file systems data. During this process, information about changes in file systems data is gathered and then all or only selected file/directory entries are mirrored using a pre-defined set of file types, file systems characteristics or other conditions.

In an embodiment, the control unit 20 is adapted to record information related to changes in file system data on the medium.

For the purpose of detecting if both file systems are synchronized, the structures of these file systems (file systems data) are read-out and compared. In order to simplify this process, a sequence number, date fields or any other relevant status information related to changes of file systems can be used. The sequence number changes each time file system data changes. Date fields comprise time information related to creation or modification of file system data.

In an advantageous embodiment, the control unit 20 is adapted to synchronize file systems data by modifying their contents in dependence on status information related to changes of file systems. For example, in case one of the two file system sequence numbers has been altered, the control unit 20 restores synchronization based on data stored on the medium.

Further, in another embodiment, the control unit 20 records the information related to changes of file system, such as sequence numbers, on the medium in a reserved area or in a special file in the GAA space. After the medium is mounted in the apparatus, this information can be read and used by the control unit 20 to perform synchronization, if necessary.

In the event of defects detected during usage of the medium, systems employing the defect management record user data in replacement areas instead of defect areas; the defect table MDT is updated accordingly. A defect table sequence number can be employed to reflect those changes. Each time the defect table is modified, the defect table sequence number is changed as well.

In an embodiment, the control unit 20 is adapted to collect information related to changes of the defect table MDT and to modify file system data in GAA (the second file system data), so those data reflect changes made to MDT. In case the sequence number of the defect table has changed, the control unit 20 can take action to restore the correct relation between the CE bridge file system and the actual location on the medium where the content is stored as a result of the defect management actions.

Again, as in case of changes of file system data, in another embodiment, the control unit 20 records the information related to changes of the defect table, such as the sequence number, on the medium in a reserved area or in a special file in the GAA space. After the medium is mounted in the apparatus, this information can be read and used by the control unit 20 to perform synchronization, if necessary.

The second file system can be chosen such as to make sure that the bridge medium will appear as “read-only” for the CE devices, or other non-MRW devices, such to ensure that no accidental overwrites occur in UA, SA or STA When such medium is removed from the CE system and put in a “MRW capable” PC drive, it can be still mounted as a normal MRW medium and more recording, e.g. by “drag-and-drop” operations, can be done.

While creating/updating the convergence file system information in GAA, some additional file system level information can be added in UA allowing for launching of a convergence (bridge) application or html screen in case of alteration of the content in UA. In this way it can be ensured that the user is aware of the necessity to re-synchronize both file systems data (in UA and GAA).

The same solution is applicable in case of a MRW capable CE device, which has modified content in UA and thus can update both file systems data.

In an embodiment, the recording apparatus is arranged as a drive unit to be connected to a separate host system, for example a drive unit to be build in a PC. The control unit 20 is arranged to communicate with a processing unit in the host system via a standardized interface.

In an embodiment of a computer data system comprising the host system and the recording apparatus, the processing unit in the host system is adapted to control the control unit 20 to perform methods and functions as described in reference to embodiments of the recording apparatus presented above.

A computer program product according to the invention is operative to cause the control unit 20 or the processing unit to perform methods and functions as described in reference to embodiments of the recording apparatus presented above.

Whilst the invention has been described with reference to preferred embodiments thereof, it is to be understood that these are not limitative examples. Thus, various modifications may become apparent to those skilled in the art, without departing from the scope of the invention, as defined by the claims. Further, the invention lies in each and every novel feature or combination of features described above. Also, for the storage medium an optical disc has been described, but other media, such as a magneto-optical disc or magnetic tape, can be used. It is noted, that the invention may be implemented by means of a general purpose processor executing a computer program or by dedicated hardware or by a combination of both, and that in this document the word “comprising” does not exclude the presence of other elements or steps than those listed and the word “a” or “an” preceding an element does not exclude the presence of a plurality of such elements, that any reference signs do not limit the scope of the claims, that “means” may be represented by a single item or a plurality and that several “means” may be represented by the same item of hardware.

1. A recording apparatus for recording digital information signals on a removable rewritable disc like recording medium, the medium comprising a user area for recording user data represented by the digital information signals and for recording first file system data comprising directory and file entries pointing to the user data according to rules of a first file system, a spare area outside the user area comprising replacement areas for defect management, a table area outside the user area for recording a defect table comprising a list of addresses of the replacement areas and defect areas in the user area, a general application area outside the user area and outside the spare area for recording second file system data comprising directory and file entries pointing to the user data according to rules of a second file system, the recording apparatus comprising
input means for receiving the digital information signals;
recording means for recording the digital information signals on the medium;
reading means for reading recorded digital information signals recorded on the medium;
output means for outputting the read digital information signals;
control means for controlling recording the digital information signals,
characterized in that the control means are adapted to mark a part of the medium as unusable in the defect table and to record the second file system data in the part of the medium marked as unusable.

2. A recording apparatus as claimed in claim 1, characterized in that the control means are adapted to mark at least a part of the spare area as unusable in the defect table and to record the second file system data in the at least the part of the spare area marked as unusable.

3. A recording apparatus as claimed in claim 2, characterized in that the control means are adapted to search the defect table for a replacement area address of a replacement area comprising recorded user data, to localize the replacement area according to the replacement area address, to search the defect table for a free replacement area address of a free replacement area without the user data, to localize the free replacement area according to the free replacement area address, to read the recorded user data from the replacement area, to record the user data read from the replacement area in the free replacement area and to mark the replacement area as unusable in the defect table.

4. A recording apparatus as claimed in claim 1, characterized in that the control means are adapted to mark a part of the user area as unusable in the defect table and to record the second file system data in the part of the user area marked as unusable.

5. A recording apparatus as claimed in claim 4, characterized in that the control means are adapted to search the defect table for a free replacement area address of a free replacement area without the user data, to localize the free replacement area according to the free replacement area address, to read recorded user data from the part of the user area, to record the user data read from the part of the user area in the free replacement area and to mark the part of the user area as unusable in the defect table.

6. A recording apparatus as claimed in claim 1, characterized in that the control means are adapted to collect change information related to changes of the first file system data or of the second file system data and to modify the first file system data or the second file system data in dependence on the change information.

7. A recording apparatus as claimed in claim 6, characterized in that the control means are adapted to record the change information on the medium.

8. A recording apparatus as claimed in claim 1, characterized in that the control means are adapted to collect status information related to changes of the defect table and to modify the second file system data in dependence on the status information.

9. A recording apparatus as claimed in claim 8, characterized in that the control means are adapted to record the status information on the medium.

10. A method of recording digital information signals on a removable rewritable disc like recording medium, the medium comprising a user area for recording user data represented by the digital information signals and for recording first file system data comprising directory and file entries pointing to the user data according to rules of a first file system, a spare area outside the user area comprising replacement areas for defect management, a table area outside the user area for recording a defect table comprising a list of addresses of the replacement areas and defect areas in the user area, a general application area outside the user area and outside the spare area for recording second file system data comprising director, and file entrics pointing to the user data according to rules of a second file system, the method characterized by
marking a part of the medium as unusable in the defect table;
recording the second file system data in the part of the medium marked as unusable.

11. A method as claimed in claim 10, characterized in that the part of the medium comprises at least a part of the spare area.

12. A method as claimed in claim 11, characterized by
searching the defect table for a replacement area address of a replacement area comprising recorded user data;
localizing the replacement area according to the replacement area address;
searching the defect table for a free replacement area address of a free replacement area without the user data;
localizing the free replacement area according to the free replacement area address;
reading the recorded user data from the replacement area;
recording the user data read from the replacement area in the free replacement area;
marking the replacement area as unusable in the defect table.

13. A method as claimed in claim 10, characterized in that the part of the medium comprises a part of the user area.

14. A method as claimed in claim 13, characterized by
searching the defect table for a free replacement area address of a free replacement area without the user data;
localizing the free replacement area according to the free replacement area address;
reading recorded user data from the part of the user area;
recording the user data read from the part of the user area in the free replacement area;
marking the part of the user area as unusable in the defect table.

15. A method as claimed in claim 10, characterized by
collecting change information related to changes of the first file system data or of the second file system data;
modifying the first file system data or the second file system data in dependence on the change information.

16. A method as claimed in claim 15, characterized by recording the change information on the medium.

17. A method as claimed in claim 10, characterized by
collecting status information related to changes of the defect table;
modifying the second file system data in dependence on the status information.

18. A method as claimed in claim 17, characterized by recording the status information on the medium.

19. A computer data system comprising a computer connected to a recording apparatus for recording digital information signals on a removable rewritable disc like recording medium, the medium comprising a user area for recording user data represented by the digital information signals and for recording first file system data comprising directory and file entries pointing to the user data according to rules of a first file system, a spare area outside the user area comprising replacement areas for defect management, a table area outside the user area for recording a defect table comprising a list of addresses of the replacement areas and defect areas in the user area, a general application area outside the user area and outside the spare area for recording second file system data comprising directory and file entries pointing to the user data according to rules of a second file system, the recording apparatus comprising
input means connected to the computer for receiving the digital information signals;
recording means for recording the digital information signals on the medium;
reading means for reading recorded digital information signals recorded on the medium;
output means for outputting the read digital information signals to the computer;
control means for controlling recording the digital information signals,
characterized in that the computer is adapted to control the control means of the recording apparatus to perform the method according to any of claims 10-18.

20. A computer program product for recording digital information signals on a removable rewritable disc like recording medium, which program is operative to cause a processor to perform the method according to any of claims 10-18.
